(19) United States
(12) Patent Application Publication
(10) Pub. No.: US 2006/0155162 A1
(43) Pub. Date: Jul. 13, 2006

(54) Self-contained light for infant care apparatus

(76) Inventor: Matthew L. Severns, Kensington, MD (US)

Correspondence Address: ROGER M. RATHBUN, 13 MARGARITA COURT, HILTON HEAD ISLAND, SC, 29926, US

(21) Appl. No.: 11/032,897

(22) Filed: Jan. 11, 2005

(51) Int. Cl. A61G 11/00

(52) U.S. Cl. 600/22

(57) ABSTRACT

An infant care apparatus for supporting an infant upon an infant platform having a self-contained procedure light that is adapted to direct light onto an infant resting on the infant platform. The self-contained procedure light generally includes a light bulb, an enclosure, a light socket and a diffuser in a common unit and is mounted to an overhead housing that is above the infant platform and which has a lower surface that faces the infant platform. The self-contained procedure light is removable and replaceable from the lower surface of the overhead housing by a convenient, easy means so that the light bulb contained within the self-contained procedure light can be easily replaced without disassembly of the overhead housing.

### BACKGROUND

The present invention relates to an infant care apparatus and, more particularly, to a procedure light used with an infant care apparatus that is fully self-contained and is readily removable as a unit for maintenance such as replacement of the light bulb.

In the care of newborn infants, there is an infant warmer apparatus that is used to provide warming of the infant and to supply the necessary heat to maintain the infant at a predetermined temperature. The infant warmer basically comprises an infant platform having a planar surface on which the infant is positioned and which planar surface normal includes side guards to keep the infant safely within the confines of the apparatus.

Infant warmers also have an overhead radiant heater that is located above the infant and which thus radiates energy in the infrared spectrum to impinge upon the infant to maintain the infant at the desired temperature. With infant warmers, since the infant is otherwise totally exposed to the surroundings, there is almost unlimited access to the infant by the attending personnel to perform various procedures on that infant. A typical infant warmer is shown and described in U.S. Pat. No. 5,474,517 of Falk et al as prior art to that patent.

Since there is such wide open access to the infant, the infant warmer is used where there is some intervention or procedure to be carried out on the infant while resting on the planar surface. Since some, if not all, of such procedures are delicate, it is normally necessary to have some source of illumination of the infant so that the attending personnel can have sufficient light to view the infant in carrying out the particular procedure.

One of the difficulties, or drawbacks, with the use of such procedure lights, however, is that there is a normal maintenance that needs to be performed on the procedure light in that the bulb must be replaced on a scheduled basis in order to assure the continued use of the infant care apparatus without interruption. At the present, many of the procedure lights are built into the overhead heater housing and the removal of the components of the light for replacement of the bulb are, for example, quite laborious and require considerable disassembly of the heater housing to obtain access to the bulb.

In many instances, the light bulbs are replaced through the upper area of the heater housing and a qualified technician must carry out the procedure since it involves the aforedescribed disassembly of the heater housing to obtain the access to the bulb and, of course, reassembly of the procedure light and the overhead heater housing after the bulb has been replaced. Obviously, any downtime for an infant care apparatus is not desirable since the equipment may be in constant use and therefore the time that any piece of infant apparatus is out of service while a light bulb is being replaced is disadvantageous to the health care facility.

Thus, it would be advantageous to have a procedure light that can be removed from the overhead heater housing as a unit through the lower surface of the heater housing by a relatively simple means so that the replacement of the bulb in the procedure light is facilitated with only a minimum of downtime of the infant apparatus.

### SUMMARY OF THE INVENTION

The present invention relates to an infant care apparatus, such as an infant warmer, that has a procedure light that is adapted to direct light onto the infant and wherein that procedure light is a self-contained unit, including the replaceable bulb, and which is built into the overhead housing of an infant apparatus in a manner that the entire self-contained procedure light is readily removable from the overhead housing in order to facilitate the bulb replacement, and just as readily replaced back into the overhead housing.

Thus, with the present infant care apparatus, the overhead housing which normally will also be used for mounting of the radiant heater, includes the procedure light that is removable and replaceable through the lower surface of the overhead housing so that the entire self-contained procedure light can be easily accessed for replacement of the bulb.

In one embodiment, the self-contained procedure light includes an enclosure, a light socket, a light bulb and a diffuser as a common unit that that is affixed to the overhead housing through the lower surface thereof.

The means of affixation of the self-contained procedure light to the overhead housing may be by a variety of methods, one of which is to provide a peripheral flange on the self-contained procedure light. As such the overhead housing can have a suitable opening formed therein so that the self-contained procedure light can be inserted upwardly through the opening and the peripheral flange then secured to the lower surface surrounding the opening by means such as screws and the like.

In another embodiment, the exterior of the enclosure of the self-contained procedure light can have threads formed thereon, either male or female, such that the self-contained procedure light can be threadedly engaged to the lower surface of the overhead housing and thus unscrewed for the removal of the self-contained procedure light and screwed back in to the overhead housing after replacement of the light bulb. There may be corresponding threads formed on the overhead housing or the threads of the self-contained procedure light may simply interact with the predetermined configuration of the opening in the lower surface of the housing and the threads directly be threaded to the interior edge of the opening.

These and other features and advantages of the present invention will become more readily apparent during the following detailed description taken in conjunction with the drawings herein.

### BRIEF DESCRIPTION OF THE DRAWINGS

FIG. 1 is a perspective view of an infant warming apparatus having a procedure light that is usable in accordance with the present invention;

FIG. 2 is a schematic side view of one embodiment of the present invention, and

FIG. 3 is a schematic side view of an alternative embodiment of the invention.

### DETAILED DESCRIPTION OF THE INVENTION

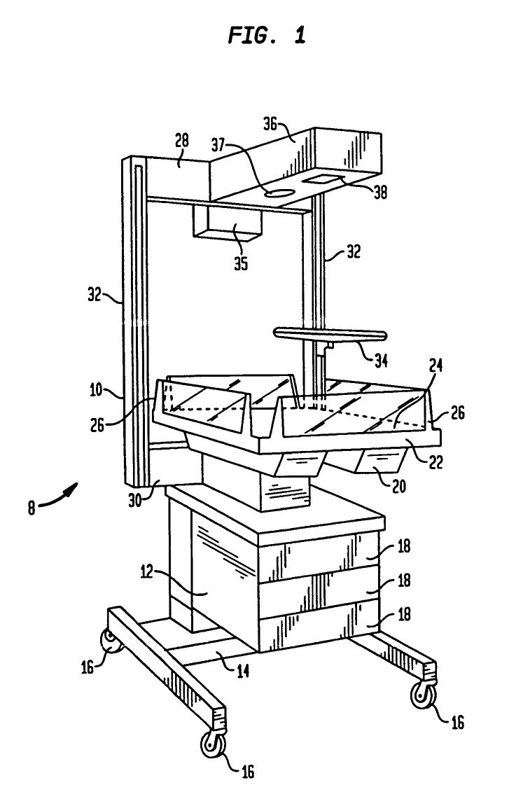

Referring now to FIG. 1, there is shown a perspective view of an infant warmer 8 constructed in accordance with the present invention. It should be noted that the present invention is described specifically with respect to an infant warmer, however, the present invention is equally applicable to other patient care apparatus that supports a patient underneath an overhead housing for treatment of that patient and where there is a light in that overhead housing used to illuminate the infant. As shown, the infant warmer 8 includes a frame 10 which provides a free standing unit for the infant warmer 8. The frame 10 is support upon a cabinet 12 which, in turn, is mounted upon a base 14 having wheels 16 so that the infant warmer 8 is easily movable. The cabinet 12 may also include one or more drawers 18 for containing items for attending to the infant.

An infant platform 20 is mounted atop of the cabinet 12 and on which is located an infant bed 22 which underlies and supports an infant positioned thereon. Infant platform 20 is the main support for the infant bed 22. The infant bed 22 has a generally planar upper surface 24 with appropriate cushioning material for comfort of the infant and further may be surrounded by guards 26, generally of a clear plastic material that contains the infant on the upper surface 24. Normally, the guards 26 are removable and/or releasable for complete access to the infant.

Frame 10 includes upper and lower cross members 28 and 30, respectively, joining a pair of vertical struts 32 and which vertical struts 32 may provide a means of support for other structural components such as a shelf 34.

Mounted on the upper cross member 28 may be a control module 36 that is conveniently positioned intermediate the vertical struts 32 and can include displays of various monitored parameters as well as include the various controls for operation of the functions of the infant warming apparatus 8. In addition, there is an overhead housing 38 mounted to the upper cross member 28 and which contains a radiant heater 40 that directs infrared energy toward an infant lying on the infant bed 22 in order to provide warmth to the infant. The overhead housing 40 has a lower surface 42 that faces the infant platform 20 and the infant bed 22.

As also can be seen in FIG. 1 there is a self-contained procedure light 44 that is normally mounted in the overhead housing 38 and which makes the self-contained procedure light 44 accessible for removal and replacement through the lower surface 42 of the overhead housing 38.

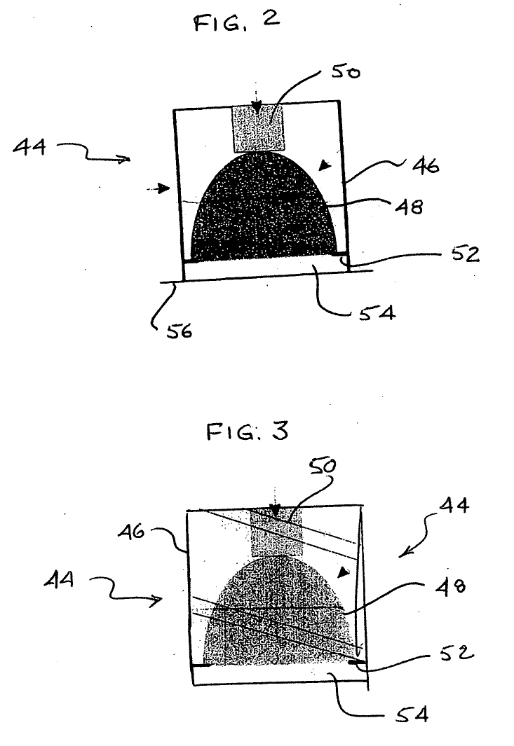

Turning now to FIG. 2, taken along with FIG. 1, there is a schematic side view of one embodiment of the present invention and illustrating a self-contained procedure light 44 that is usable in accordance with the present invention. Accordingly, as can be seen, the self-contained procedure light 44 comprises an enclosure 46 containing a light bulb 48 that is plugged into a socket 50 for providing the electrical power to the light bulb 48.

The light bulb 48 can be held in its position within the enclosure 46 by means of a retainer 52 and a diffuser 54 covers the open end of the enclosure 46 such that all light emanating from the light bulb 48 passes through the diffuser 54 to diffuse the light as it is transmitted toward the infant platform 20. There is also a peripheral mounting flange 56 located at the open end of the enclosure 46 and the mounting flange 56 is used to attach the self-contained procedure light 44 to the lower surface 42 of the overhead housing 38 by means such as screws, clips or some other quick connection devices (not shown).

Thus, as can now be seen, the self-contained procedure light 44 can be fitted up into an opening formed in the overhead housing 38 such that the mounting flange 56 can simply be attached to the inner edge of that opening in the lower surface 42 of the overhead housing 38 and the self-contained procedure light 44 can therefore be easily removed from the overhead housing 38 and replaced therein by the simple removal and replacement of screws or like devices. Since the entire self-contained procedure light 44 is therefore removable from the overhead housing 38 through the lower surface 42, it can readily be removed in order to change the light bulb 48 and then just as easily replaced and there is no need for further disassembly of the overhead housing 38. There may, of course, be an excess of wiring that is affixed to the self-contained procedure light 44 to allow the self-contained procedure light 44 to drop downwardly for easy replacement of the bulb or the self-contained procedure light 44 may itself be removable plugged into a socket fixed within the overhead housing 38.

Turning now to FIG. 3, taken along with FIG. 1, there is shown a schematic view of an alternative embodiment, wherein the components are the same as shown in FIG. 2 and the same identification numbers utilized, however, in the embodiment of FIG. 3, there are threads 58 formed on the exterior of the enclosure 46 so that the self-contained procedure light 44 can be screwed up into and out of the lower surface 42 of the overhead housing 38. As can be understood, the threads 58 can be male or female threads and can mate to the opening in the lower surface 42 of the overhead housing 38 or be threaded to corresponding threads (not shown) formed in the overhead housing 38.

Accordingly, with this embodiment, the enclosure 46 of the self-contained procedure light 44 can simply be screwed out of its location in the lower surface 42 of the overhead housing 38 to easily remove the self-contained procedure light 44 from the overhead housing 38 for removal of the light bulb 48 and, once the light bulb 48 has been replaced, the enclosure 46 can then easily be screwed back into the lower surface 42 of the overhead housing 38 to return the infant apparatus 8 to its use in the health car facility.

Those skilled in the art will readily recognize numerous adaptations and modifications which can be made to the infant care apparatus of the present invention which will result in an improved mounting for a procedure light in the infant care apparatus, yet all of which will fall within the scope and spirit of the present invention as defined in the following claims. Accordingly, the invention is to be limited only by the following claims and their equivalents.

I claim:

1. A patient care apparatus, said patient care apparatus comprising a base having a patient platform on which a patient is adapted to be positioned, an overhead housing affixed to the base and located above the patient platform and having a lower surface facing the patient platform, a self-contained procedure light affixed within the overhead housing and including a light bulb, said self-contained procedure light being removable as a unit through the lower surface of the overhead housing for access to the light bulb.

2. The patient care apparatus as defined in claim 1 wherein the patient care apparatus is an infant care apparatus having an infant platform.

3. The infant care apparatus as defined in claim 2 wherein said overhead housing contains a heater adapted to direct heat toward the infant platform.

4. The infant care apparatus as defined in claim 2 wherein said overhead housing has an opening formed in the lower surface to allow the self-contained procedure light to fit through said opening upwardly into the overhead housing.

5. The infant care apparatus as defined in claim 4 wherein said self-contained procedure light has a flange adapted to be secured to the internal edge of the opening formed in the lower surface of the overhead housing.

6. The infant care apparatus as defined in claim 4 wherein the self-contained procedure light comprises an enclosure having threads formed thereon.

7. The infant care apparatus as defined in claim 6 wherein the enclosure has external threads formed thereon.

8. The infant care apparatus as defined in claim 6 wherein the opening in the lower surface of the housing has an internal edge and wherein the enclosure is threadedly engaged to the internal edge of the opening.

9. The infant care apparatus as defined in claim 6 wherein the lower surface of the housing has threads formed surrounding the opening and wherein the enclosure of the self-contained procedure light is threadedly engaged to the threads formed surrounding the opening.

10. The infant care apparatus as defined in claim 1 wherein said self-contained procedure light includes an enclosure, a light socket, a light bulb and a diffuser.

11. A method of replacing a light bulb in the self-contained procedure light in a patient care apparatus, said method comprising the steps of:
providing a patient care apparatus having a patient platform adapted to support a patient and an overhead housing having a lower surface located above the patient platform;
providing a self-contained procedure light having a bulb affixed within the overhead housing;
removing the self-contained procedure light through the lower surface of the overhead housing;
replacing the bulb within the self-contained procedure light; and
returning the self-contained procedure light to its location through the lower surface of the overhead housing.

12. The method as defined in claim 11 wherein the step of providing a patient care apparatus comprises providing an infant care apparatus having an infant platform.

13. The method as defined in claim 12 wherein the step of providing a self-contained procedure light comprises providing a self-contained procedure light having a peripheral flange.

14. The method as defined in claim 13 wherein the step of removing the self-contained procedure light comprises detaching the peripheral flange from the lower surface of the overhead housing.

15. The method as defined in claim 12 wherein the step of providing a self-contained procedure light comprises providing a self-contained procedure light having threads formed thereon.

16. The method as defined in claim 15 wherein the step of removing the self-contained procedure light comprises unscrewing the threaded self-contained procedure light from the lower surface of the overhead housing and the step of returning the self-contained procedure light comprises screwing the self-contained procedure light to the lower surface of the overhead housing.

17. The method as defined in claim 12 wherein the step of providing a self-contained procedure light comprises providing a self-contained procedure light comprising an enclosure, a light socket, a light bulb and a diffuser.
